(19) United States
(12) Patent Application Publication
(10) Pub. No.: US 2025/0334690 A1
(43) Pub. Date: Oct. 30, 2025

(54) RESOURCE MANAGEMENT OF SYNTHETIC APERTURE RADAR IN A MOBILE DEVICE

(71) Applicant: Telefonaktiebolaget LM Ericsson (publ), Stockholm (SE)

(72) Inventors: Gang ZOU, Lund (SE); Fredrik DAHLGREN, Lund (SE); Henrik SJÖLAND, Lund (SE); Magnus SANDGREN, Staffanstorp (SE); Magnus OLSSON, Klagshamn (SE); Ashkan KALANTARI, Malmö (SE)

(21) Appl. No.: 18/866,138

(22) PCT Filed: Jun. 23, 2022
(86) PCT No.: PCT/EP2022/067137

§ 371 Date: Nov. 15, 2024

(51) Int. Cl. G01S 13/90; H04W 52/02; H04W 68/00

(52) U.S. Cl. CPC G01S 13/9021; H04W 52/0209; H04W 68/00

(57) ABSTRACT

A synthetic aperture radar (SAR) image of a target is produced. The production involves a mobile communication device and comprises causing a SAR image process to be performed, wherein the SAR image process comprises a plurality of SAR process actions including obtaining SAR data by operating a transceiver of the mobile communication device to receive reflections of a radar signal transmitted at each of a plurality of different positions of the mobile communication device relative to the target, and producing the SAR image from the SAR data. Causing the SAR image process to be performed includes causing the mobile communication device to perform a first set of the SAR process actions; and causing the one or more nodes in a network to perform a second set of the SAR process actions. Allocation of the SAR process actions between the first set of the SAR process actions and the second set of the SAR process actions is based on an evaluation of one or more criteria.

### BACKGROUND

The present invention relates to technology that enables a mobile communication device to perform synthetic aperture radar sensing of its environment, and more particularly to technology for performing synthetic aperture radar sensing in a resource-efficient way.

There is increasing interest in radar systems having the capability of detecting concealed items. Such capability is facilitated by the use of mm Wave radiofrequency (RF) radar signals, which can penetrate materials, such as cloth or different types of casings.

It is also known that high resolution radar images can be obtained by employing synthetic aperture radar (SAR) processing techniques. Typically, SAR images of an object are produced by performing radar measurements from varying positions relative to the object. The radar data collected from these different positions is then combined to form the high resolution radar image.

Thus, by employing SAR processing to radar data obtained from mmWave RF signals, concealed objects can be detected with high resolution.

There is presently a trend to integrate mmWave radar capability into mobile devices. For example, one such device is equipped with a 60 GHz low power radar platform. This creates the opportunity for promising applications and features that involve the mobile device scanning an area and detecting concealed objects (e.g., behind or inside a wall, box, etc.).

While SAR radar has the advantage of being able to achieve a higher spatial resolution than conventional radar, it has the disadvantages of higher power consumption (higher duty cycle relative to individual radar reflections that are analyzed) as well as the fact that the radar device needs to be moving in some way (i.e., in order to perform the scans at different positions). The movement can be that of the scanning device, but in many situations, the device is not moving but is instead turning, thereby creating an angular movement of the radar and reflection beams.

A related approach is inverse-SAR (ISAR), in which the radar device is fixed but the targeted object is moving. See, for example, A. Zhuravlev et al. “Inverse synthetic aperture radar imaging for concealed object detection on a naturally walking person”, Proceedings of SPIE Vol. 9074 May 2014. ISAR has the same power consumption disadvantages as a SAR radar for a battery-operated device.

At present, “normal” (i.e., non-SAR) radar capability can be incorporated into mobile devices, such as extensions to a 5G modem device. Equipping mobile devices to use mm Wave radar signals and also SAR and ISAR processing has also been explored. However, conventional technology has not addressed the shortcomings noted above.

US20200132832 focuses on the implementation of a distance sensing unit with a radar unit and various applications. It includes an “opportunistic SAR” process by reading Inertial Measurement Unit (IMU) data. However, it does not include the use of mmWave radar to look through a concealed structure, and nor does it fully solve the need for high power consumption.

US2019305859A1 primarily describes a radar RF implementation in a mobile device. In one embodiment, a buffer follows an analog to digital converter (ADC) to store a digital baseband signal.

US2018199377A1 deals with co-existence between mmWave communications and radar in a mobile device. The document describes performing radar operations during communication sleep periods.

Today, most hand-held/head-mounted devices are powered by battery. Compared with single-shot radar sensing, SAR/ISAR scanning and related data processing require more resources (e.g., more computation load and radio-on time) and furthermore consume more power/energy. Therefore, there is a need for SAR scanning and image reconstruction technology that addresses the above and/or related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) that is for producing a synthetic aperture radar (SAR) image of a target. The technology causes a SAR image process to be performed, wherein the SAR image process comprises a plurality of SAR process actions comprising obtaining SAR data by operating a transceiver of the mobile communication device to receive reflections of a radar signal transmitted at each of a plurality of different positions of the mobile communication device relative to the target; and producing the SAR image from the SAR data. In an aspect of embodiment, causing the SAR image process to be performed comprises causing the mobile communication device to perform a first set of the SAR process actions; and causing the one or more nodes in the network to perform a second set of the SAR process actions. Allocation of the SAR process actions between the first set of the SAR process actions and the second set of the SAR process actions is based on an evaluation of one or more criteria.

In an aspect of some but not necessarily all embodiments consistent with the invention, the one or more criteria are dependent on one or more of:
a power constraint of the mobile communication device;
a processing resource constraint of the mobile communication device;
a buffer constraint of the mobile communication device;
an amount of power consumption required to communicate between the mobile communication device and the one or more nodes in the network; and
a target resolution of the SAR image.

In another aspect of some but not necessarily all embodiments consistent with the invention, the one or more criteria include a maximum latency requirement.

In another aspect of some but not necessarily all embodiments consistent with the invention, the determining comprises estimating an amount of time that is attributable to trajectory guidance activity.

In yet another aspect of some but not necessarily all embodiments consistent with the invention, the trajectory guidance activity includes communicating trajectory guidance from the one or more nodes in the network to a controller of a mechanical scanner that moves the mobile communication device, wherein the trajectory guidance comprises instructions for controlling the mechanical scanner.

In still another aspect of some but not necessarily all embodiments consistent with the invention, the trajectory guidance activity includes receiving trajectory guidance from the one or more nodes in the network to the mobile communication device, wherein the trajectory guidance comprises information to be presented to a user of the mobile communication device, wherein the information comprises one or more of: text information; audible information; tactile information to be presented to the user; and visual information to be displayed to the user.

In another aspect of some but not necessarily all embodiments consistent with the invention, the trajectory guidance activity includes communicating position information from the mobile communication device to the one or more nodes in the network, wherein the position information includes one or more of a geographic location of the mobile communication device, an orientation of the mobile communication device, and an acceleration vector.

In yet another aspect of some but not necessarily all embodiments consistent with the invention, the trajectory guidance activity includes receiving radar scan control from the one or more nodes in the network, wherein the radar scan control comprises instructions for controlling one or more of a direction of a radar scan performed by the mobile communication device; a scanning speed of the radar scan performed by the mobile communication device; and a radar sampling step of the radar scan performed by the mobile communication device.

In still another aspect of some but not necessarily all embodiments consistent with the invention, the trajectory guidance activity includes communication of object control information that controls movement of an object to be scanned by the SAR image process.

In another aspect of some but not necessarily all embodiments consistent with the invention, the technology adjusts a SAR processing speed based on a measure of available memory for storing SAR data.

In yet another aspect of some but not necessarily all embodiments consistent with the invention, the technology adjusts how frequently collected SAR data is communicated to the one or more network nodes based on a measure of available memory for storing the collected SAR data.

In still another aspect of some but not necessarily all embodiments consistent with the invention, the technology adjusts a speed of performance of the SAR image process based on a level of interaction between the mobile communication device and the one or more nodes in the network that is related to scanning trajectory guidance.

In another aspect of some but not necessarily all embodiments consistent with the invention, the technology adjusts a speed of performance of the SAR image process based on a threshold level of maximum acceptable processing latency.

In yet another aspect of some but not necessarily all embodiments consistent with the invention, the SAR process actions comprise determining further radar scans that need to be performed by the mobile communication device to obtain the SAR data.

In still another aspect of some but not necessarily all embodiments consistent with the invention, the mobile communication device periodically activates a wireless transceiver to perform a network activity at predefined instances, wherein the network activity comprises one or more of receiving and transmitting a signal respectively from and to the network, and wherein the technology causes the mobile communication device to perform radar scans in between the predefined instances. Radar information obtained from the radar scans is stored in a buffer. The mobile communication device is maintained in an awake state throughout a time interval during which the mobile communication device performs the network activity at one or more of the predefined instances; and communicates the stored radar information to the one or more nodes of the network.

In another aspect of some but not necessarily all embodiments consistent with the invention, the network activity comprises monitoring paging information from the network.

### BRIEF DESCRIPTION OF THE DRAWINGS

The objects and advantages of the invention will be understood by reading the following detailed description in conjunction with the drawings in which:

FIG. 1A is a block diagram of an exemplary system that is consistent with inventive embodiments.

FIG. 1B shows a system overview of the circuits in a mobile device that is consistent with inventive embodiments.

FIG. 2 illustrates scanning portions of a SAR imaging system that implements spatial sampling over the x-y plane from a distance, z₀.

FIG. 3 is, in one respect, a flowchart of actions of a SAR image process performed by an exemplary device configured to perform SAR scanning in accordance with some embodiments consistent with the invention.

FIGS. 4A and 4B illustrate a mobile device being rotated around the z-direction to form a circular SAR scanning trajectory.

FIG. 5A shows actions performed in connection with production of a SAR image in accordance with some aspects of embodiments consistent with the invention.

FIG. 5B shows further aspects of SAR operation in accordance with some embodiments consistent with the invention.

FIG. 6 is, in one respect, a flowchart of actions performed by an exemplary mobile communication device configured to perform SAR sensing and SAR processing allocation in accordance with a number of embodiments consistent with the invention.

FIG. 7 shows dynamic switching between different modes of SAR processing allocation.

FIG. 8A illustrates a radar operation being performed in between communication paging receptions, with the collected radar data being uploaded just following the next-occurring communication paging reception instance.

FIG. 8B shows radar data collection being performed in each of two DRX cycles, and the uploading of radar data being performed only after the last occurring communication paging reception instance associated with the multiple DRX cycles.

FIG. 9 shows an exemplary controller that may be included in a device to cause any and/or all of the herein-described and illustrated actions associated with the device to be performed.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

To ease the description, the various aspects and embodiments presented herein make reference to SAR (e.g., “SAR processing”, “SAR process actions”, etc.). However, unless it is specifically stated otherwise, any reference to “SAR” is intended to cover not only SAR, but also ISAR. Accordingly, inventive aspects described herein are applicable to SAR and also to ISAR.

As mentioned above, it is advantageous to equip mobile devices with SAR functionality, including mmWave SAR. However, SAR scanning and related data processing require more resources (e.g., more computation load and radio-on time) and furthermore consume more power/energy, and this can be problematic for battery-powered mobile devices. To address these problems, embodiments consistent with the invention recognize that SAR processing comprises a number of separate SAR process actions and, in one aspect, divide the SAR process actions between local processing (performed by the mobile device) and a remote processing entity (e.g., cloud processing). In this way, the mobile device does not shoulder the entire burden of the SAR processing. For example, the allocation can be made such that local SAR processing is assigned the task of reconstructing a low resolution image to guide the SAR trajectory, while the remote processing is allocated the job of reconstructing a higher resolution image from the collected radar data. This allocation preserves the device's battery time while still being able to quickly provide the feedback for updating the SAR trajectory guidance.

In some but not necessarily all embodiments, while performing SAR scanning, a device enables only its RF circuits and ADC for the radar operation and buffers the radar data while the radar/SAR digital processor is maintained in a deep sleep state (e.g., being powered off). Once the amount of the buffered data reaches a threshold amount, the radar/SAR digital processor is enabled to do the radar data processing. This reduces the high peak power consumption during SAR scanning.

In another aspect of some but not necessarily all embodiments consistent with the invention, when SAR digital processing is performed locally, the device's power consumption is reduced by reducing the speed of the digital processing circuit to a minimum (or at least to a lower speed that will still enable any latency constraints to be satisfied). The lower processing speed is determined by the required processing latency constraints which are determined by:
a. Available SAR data memory buffer, since a larger buffer allows the processing latency to be increased (i.e., since it takes a longer amount of time before the buffer becomes full).
b. The level of trajectory guidance activity that is needed, since this can reduce the amount of digital processing required. The level of trajectory guidance activity will be application-dependent, and so may be estimated in different ways, depending on circumstances. To give one, non-limiting example, it can be estimated based on whether some features of a scan target require more guidance to obtain a proper scan.

In another aspect of some but not necessarily all embodiments consistent with the invention, the timing of SAR scanning and SAR data processing is coordinated with other device activities (e.g., communication activities) to more efficiently use resources and thereby save power. For example, radar operations can be time aligned with communication activities during communication paging discontinuous reception (DRX) cycles in idle mode. Such a strategy leads to power reduction because, by processing most of the latency critical parts locally (i.e., within the device) less pressure is placed on the turn around latency that the external processing node(s) must satisfy, and this relaxation of latency requirements then allows for more coordination with other RF activities over the radio interface. The coordination then reduces RF interface related power consumption.

These and other aspects of inventive embodiments are now further described in the following.

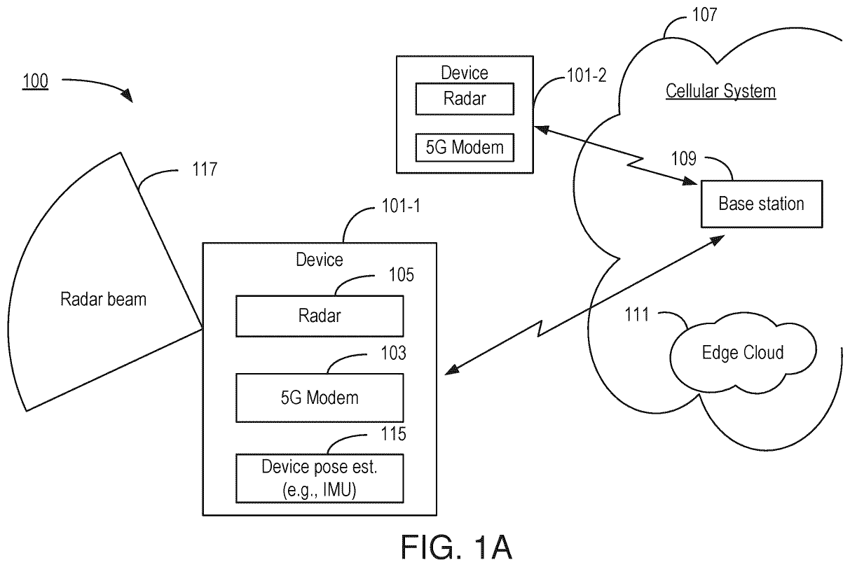

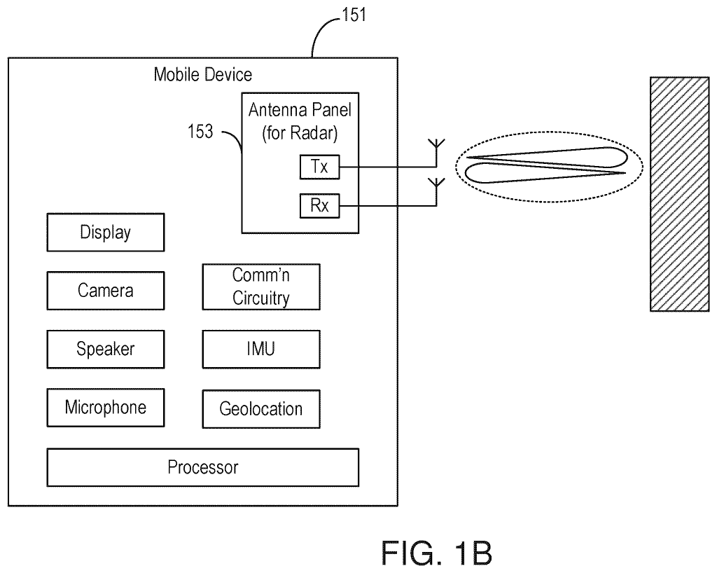

FIG. 1A is a block diagram of an exemplary system 100 that is consistent with inventive embodiments. The exemplary system 100 comprises:
Mobile communication devices (or User Equipment-UE) 101-1, 101-2, each comprising a modem 103 and configured with Radar functionality 105 (implemented either by using the modem 103 or with separate radar circuitry as shown in FIG. 1A). There may be more or fewer of such devices in any particular embodiment.
A cellular communication system 107 comprising a base station 109 that the devices 101-1, 101-2 communicate with.
An edge cloud 111, which is taken here to refer to a network of one or more processing and/or storage entities that are accessible to any of the mobile communication devices 101-1, 101-2 via the base station 109. It is advantageous for the edge cloud 111 to reside at or near the base station 109 so that it can provide services that are local to the area served by the base station 109 and do so with lower latencies than going over-the-top to a data center (not shown) farther away. However, locating the edge cloud 111 at or near a base station is neither a necessary nor an essential aspect of inventive embodiments.
A device pose (also known as “orientation”) estimator 115, for example using an IMU onboard the device (very accurate) or alternatively calculated based on beam alignment towards a known reference (lower accuracy) or in another alternative using a radio-based angle measurement (medium accuracy), such as by using beam direction from a UE antenna panel towards the base station 109 as a reference in the spatial domain. The Angle of Arrival (AoA) and Angle of Departure (AoD) can together with Round Trip Time (RTT) measurements generate the coarse position and panel pose towards the base station 109.

These elements are discussed further in the following. To ease the description, unless it is necessary to distinguish one mobile communication device from another (e.g., to distinguish a first mobile communication device 101-1 from a second mobile communication device 101-2), a mobile communication device will generically be referred to herein as a mobile communication device 101.

### Mobile Devices/UE's 101

It is advantageous to utilize mobile communication devices 101 that are equipped with radar functionality 105. Such functionality can be implemented as, for example, a separate circuit and/or component. It is further advantageous, however, to do this by means of a modem 103 configured not only to perform communication functions, but also to generate and transmit radar beams 117 and to receive reflected radar signals. A UE modem 103 can be extended with radar capabilities in accordance with known techniques. One such teaching is found in PCT Patent Application No. PCT/EP2020/069491. The added cost of the radar functionality on top of that of an ordinary 5G modem is then minimal due to the ability to share antenna panels occupying a valuable space in a device. This means that the modem 103 can be used for several purposes:
Allowing the mobile communication device 101 to operate in the cellular system 107, communicating with the base station 109 not only for conventional communication purposes but also to interact with the edge cloud 111 to support SAR processing, as is described further below.
Providing radar transmission and reception functionality in the mobile communication device 101. The modem 103 can be dynamically configured to carry out radar sensing at different frequencies, different beam directions, and with different signaling types and durations with no or minimal impact on any current 5G communication.

In some but not necessarily all alternative embodiments, the radar functionality 105 is implemented as a separate module that needs to be carefully setup to coexist (without causing significant interference) with a 5G modem in order to perform the joint operation as described herein. This adds cost and complexity.

In still further alternatives, it is noted that despite references to 5G-compliant modems herein, those of ordinary skill in the art will readily understand that a modem that is compliant with other communication standards or generations of 3GPP standard can instead be used.

The mobile devices 101 might be equipped with an IMU (e.g., combination of accelerometer, gyroscopic sensor, and possibly also magnetometer/compass) for estimation 115 of orientation of the device, and the estimate the direction of the radar beams. However, alternative embodiments that are capable of equivalent functions by alternative means are also considered to be included among inventive embodiments.

### Cellular System and Base Station 109 Support

The cellular system, including the base station 109, support the mobile communication device's access to the edge cloud 111, and therefore at least indirectly facilitate the SAR processing technology described herein.

### Mobile Edge Server Function (MEF)

The edge cloud 111, located within the cellular system at, for example, the base station 109, is an important element in various inventive embodiments. In one aspect, the edge cloud 111 has at least partial and in some embodiments full SAR image processing functionality (e.g., the ability to produce a complete SAR image from SAR radar data). In some but not necessarily all embodiments, the edge cloud 111 is also able to produce guidance for the SAR scanning trajectory, and can communicate this to, for example, the mobile communication device 101 (e.g., to instruct a user of the device about how to move the device for further obtain further scans). Alternatively the trajectory guidance can be communicated to some mechanical means for moving the scanning device or for moving an object to be scanned (e.g., in the case of ISAR) or both. The guidance for further sensing can be supplied to the mobile communication device 101 via the base station 109. These aspects are described further below.

In the exemplary embodiment illustrated in FIG. 1A, the mobile edge server 111 is a standalone entity. However, in alternative embodiments the mobile edge server 111 can be implemented as extensions to the functionalities in the base station 109 or can even be handled on an internet-connected server beyond that of the base station 109. All such alternatives are contemplated to be within the scope of inventive embodiments. It is noted, however, that it is advantageous for mobile edge server functionality to be co-located with the base station 109 given the local relevance of this function and the short latencies in the communication with the UEs.

Although in typical implementations an edge cloud 111 can be presumed to serve one base station, there are no principal obstacles preventing an edge cloud from serving many base stations. In the following, the system, the solution, and the examples assume one edge cloud 111 for this functionality, but the scope of the invention is not limited to having only one such edge cloud 111 for this.

The power saving and resource efficient principles described throughout this document are applicable to any type of SAR radar application. However, additional benefits are obtained when mmWave frequencies are used for the radar signals, since their wide bandwidth and short wavelength enables high resolution scanning. The use of mmWave frequencies has an additional advantage in that it facilitates incorporation into wireless communication devices. This is because when the wireless communication module in the mobile device is using mmWave or other wideband radio signals, the radar functionality can be implemented by re-using the hardware of the communication module. For example, as disclosed in WO2022008063, with slight hardware modifications of conventional designs, a 5G beamforming mmWave transceiver, together with its RF front end components and antenna array, can be shared between radar and communication modem. See also, International Application No. PCT/EP2022/055110. FIG. 1B shows the system overview of the mmWave circuits in such a mobile device 151. The RF transceiver, RF front-end components and the antenna array are generally integrated into a single module, called “antenna panel”, or “antenna module”. The term “antenna panel” 153 will be used hereafter throughout this description.

The SAR radar transceiver implementation can be in line with that which is disclosed in WO2008073011, whereas the implementation of the single-shot radar can be in line with WO2022008063. Hardware implementations of a radar design with the capability of SAR as well as single-shot radar are known in the art, so a complete description of this technology is beyond the scope of this disclosure.

To facilitate an understanding of various aspects of inventive embodiments, a brief introduction of SAR image reconstruction as performed by a mobile device is set out in the following. For more detailed information, reference is made to D. M Sheen et al., “Three-Dimensional Millimeter-Wave Imaging for Concealed Weapon Detection”, IEEE Trans. On Microwave Theory and Techniques, Vol. 49, No. 9, September 2001; and also to M. E. Yanik and M. Torlak, “Near-Field 2-D SAR Imaging by Millimeter-Wave Radar for Concealed Item Detection”, 2019 IEEE Radio and Wireless Symposium, January 2019.

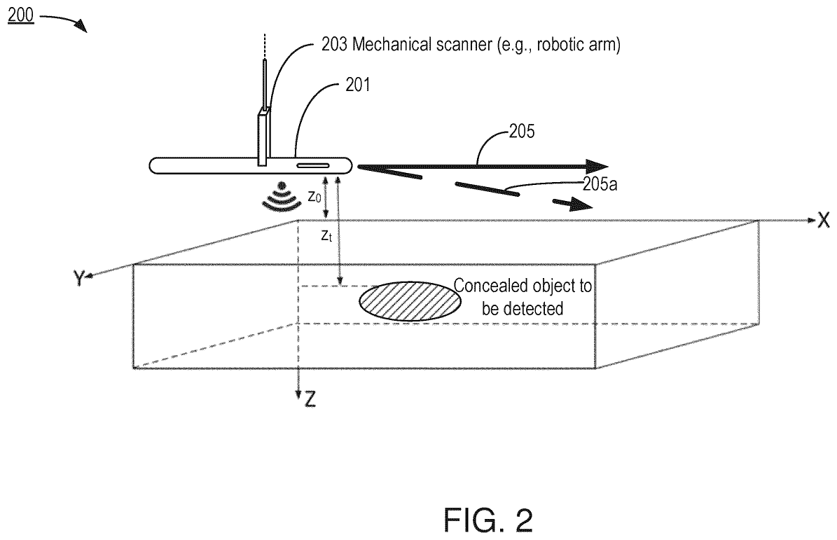

FIG. 2 illustrates scanning portions of a SAR imaging system 200 that implements spatial sampling over the x-y plane from a distance, z₀. A handheld scanning device 201 equipped with the radar full duplex transceiver having a detection range of zₜ performs the scanning. In order to collect the necessary radar data to be able to reconstruct a high resolution image by SAR processing, the device 201 is physically moved. The physical movement can be realized by a user's hand or alternatively by a controlled machine, such as the mechanical scanner 203 where the radar platform installed, as shown in the figure. In nonlimiting exemplary embodiments, the mechanical scanner 203 is a robotic arm.

Radar data is collected as the device 201 is moved along a scanning trajectory 205. Collecting the radar data as the device 201 is moved and associating each data item with the device's location at the time of collection results in a grid of measurement points. The scanning trajectory 205 can be rectangular, angular, or arbitrary, as illustrated by the dashed line 205a in the figure.

Consider an example in which frequency-modulated continuous-wave (FWCW) mmWave radar is used. The radar transmitted signal at (x,y) is

$$s ( x , y , t ) = cos ( 2 π ( {f}_{0} t + 0 \text{.5} {Kt}^{2} ) ) , 0 \leq t \leq T \qquad ( 1 )$$

where f₀ is the main carrier frequency, and K=B/T is the slope of frequency computed from the sweep bandwidth of B and the signal duration of T.

The corresponding reflection is received by the receiver antenna and mixed with the original transmitted signal to generate a complex intermediate frequency (IF) signal as,

$$r ( x , y , t ) = β exp ( j 2 π ( {f}_{0} τ + K τ t - 0 \text{.5} K {τ}^{2} ) ) , 0 \leq t \leq T \qquad ( 2 )$$

where τ is the round-trip delay of the radar reflection, Kτ is the beat frequency of the IF signal that carries the range information, and β represents the losses and gains in the radio link.

For a certain detection range (zₜ), to further improve the signal-to-noise ratio (SNR), a filtering operation can be performed on the collected signal r(x, y, t),

$${r}_{t} ( x , y ) = {\int }_{0}^{T} r ( x , y , t ) exp ( - j 2 π K {τ}_{t} t ) dt \qquad ( 3 )$$

where τₜ=2·zₜ/c, c is the speed of light, and zₜ is the detection range.

Using these coherently recorded data from all the measured points, a SAR image reconstruction algorithm (such as that described in the publication by D. M Sheen et al., cited above) can be applied to construct the final radar image at detection range zₜ.

As mentioned earlier, construction of a SAR image from the collected radar data requires knowledge of the device's scanning locations. To address this aspect, a device can use a combination of accelerometers, gyroscopes, and/or magnetometers (collectively, the IMU) to measure and report its motion (e.g., position variation, orientation, moving velocity, etc.). When the mobile device performs SAR scanning (e.g., using built-in mm Wave radar functionality), the IMU data collected along the radar SAR scanning trajectory 205 can be recorded. In alternative embodiments, image data from a camera can be used instead of, or in addition to IMU data.

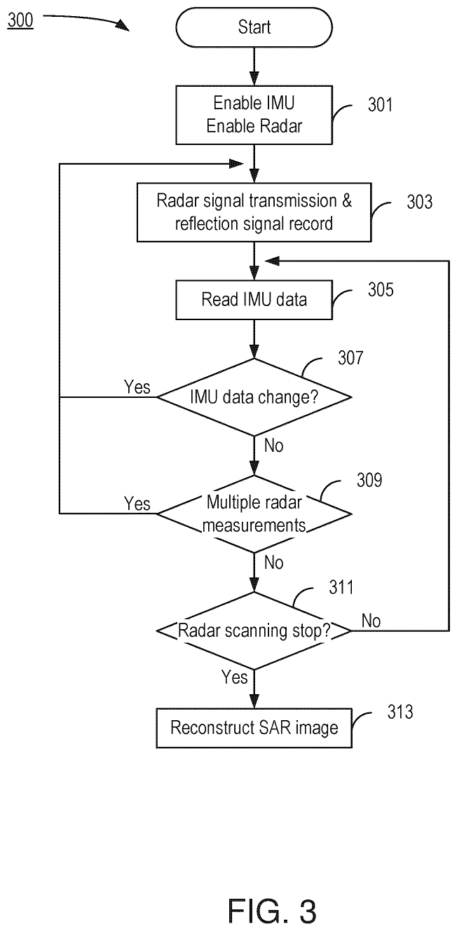

FIG. 3 is, in one respect, a flowchart of actions of a SAR image process performed by an exemplary device 151 configured to perform SAR scanning. In other respects, the blocks depicted in FIG. 3 can also be considered to represent means 300 (e.g., hardwired or programmable circuitry or other processing means) for carrying out the described actions.

As shown beginning in FIG. 3, the process includes enabling IMU and radar circuitry (step 301) and beginning a loop to collect radar data. The loop comprises transmitting radar signals and receiving and recording the reflection signals (step 303) and also reading the IMU data (step 305). If the device has changed its geographic location and/or orientation, this will be reflected as a change in the IMU data (“Yes” path out of decision block 307) so another radar signal transmission and reflection signal recordation can be made by returning to the top of the loop at step 303.

Even if the IMU data has not changed (“No” path out of decision block 307), if it is desired to make multiple radar measurements at the same location and device orientation (“Yes” path out of decision block 309) another radar signal transmission and reflection signal recordation can be made by returning to the top of the loop at step 303. Otherwise (“No” path out of decision block 309) a decision is made regarding whether to stop the radar scanning (decision block 311). For example, it may be decided that an insufficient amount of radar data has been collected at different device locations/orientations and that the scanning should continue (“No” path out of decision block 311), in which case another radar signal transmission and reflection signal recordation can be made by returning to the top of the loop at step 303. Otherwise (“Yes” path out of decision block 311) the collected information (radar data and IMU data) is processed to construct a SAR image (step 313).

By scanning on an x-y plane, a SAR image can be reconstructed from the spatially coherent radar data. However, for a manually moved device, such as a hand-held (e.g., a mobile phone) or head-mounted device (e.g., a Virtual Reality—VR—headset), the scan trajectory is affected by user movement that results in moving variations in the z direction (i.e., the scanning trajectory is not on the same x-y plane for all of the data).

To avoid introducing errors from these inaccuracies, the z-direction offsets between adjacent scanning points can be determined from IMU data, and the radar signal processing algorithm adjusted to compensate for the z-direction offsets. Taking the FMCW radar as a nonlimiting example, Equation (3) can be modified as shown in Equation (4) to compensate for the z-direction offset from the x-y plane at z₀, which is the z value of the starting position of the SAR scanning (as shown in FIG. 2).

$${r}_{t} ( x , y ) = {\int }_{0}^{T} r ( x , y , t ) exp ( - j 2 π K {\overline{τ}}_{t} t ) dt \qquad ( 4 )$$

where τ̅ₜ =2*(zₜ+Δz)/c, and Δz is the z-direction offset from x-y plan at z₀, which can be extracted from IMU reading data.

For example, when a mobile device starts SAR scanning, its IMU records the initial point (x₀, y₀, z₀) at which the radar signal is transmitted and the backscatter signal is received. When the device moves to the next position (whose coordinate is measured by IMU as (x₁, y₁, z₁)) and performs its radar operation, the z-direction offset from z₀ can be calculated as Δz=z₁−z₀.

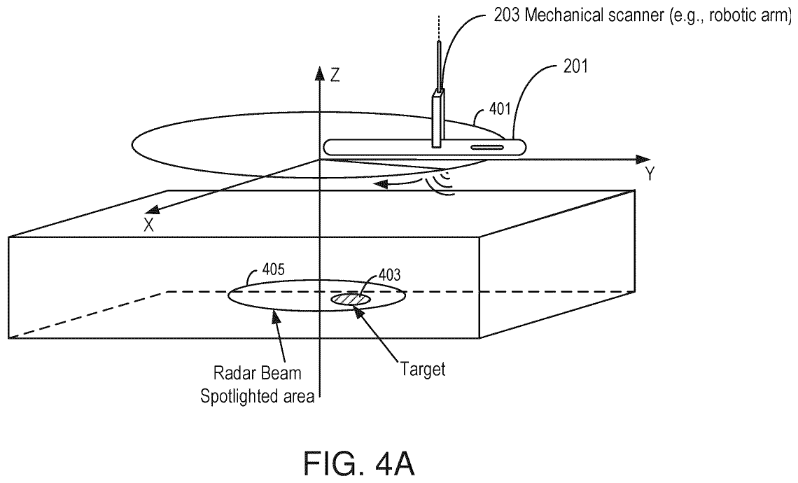

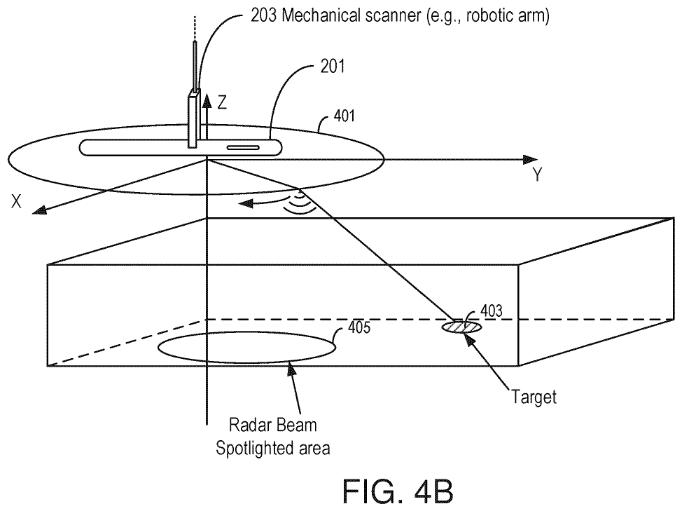

In some embodiments, the mobile device 201 is rotated around the z-direction to form a circular SAR scanning trajectory 401 as illustrated in FIGS. 4A and 4B. The IMU 115 (or other motion detector) can be enabled to collect the rotation angle, height and moving speed. When the target 403 is inside the scanning trajectory 401 (as shown in FIG. 4A), a SAR spotlight mode can be applied to reconstruct the SAR image within the spotlight area 405. When the target is outside the scanning trajectory (as shown in FIG. 4B), a method such as that described in US20200132832 can be applied for SAR image reconstruction.

As explained earlier, power consumption is a critical aspect for battery-powered mobile devices. Compared with a normal one-shot (or even multiple-shot) radar mode, a SAR scanning mode requires a much longer active duty cycle. As a result, the SAR scanning mode and the subsequent SAR image reconstruction procedure are very power hungry.

In an aspect of some embodiments consistent with the invention, the actions that make up SAR image processing (e.g., SAR data collection and SAR image reconstruction) are allocated between the mobile device and an external processing functionality. It is advantageous, as a goal of the allocation strategy, to keep power consumption at the mobile device at an acceptable level while also satisfying any constraints that might be imposed on the particular embodiment.

As a non-limiting example, a strategy can be adopted in which the device reconstructs the SAR image if it can handle the radar data processing, and otherwise transfers the radar data to an edge cloud (or cloud) via a wireless communication interface with base station. For example, it may be feasible for a device to perform all processing actions locally if the SAR scanning is confined to a small area and performed with lower resolution. However, if the SAR scanning is performed on a large area and with high resolution, it might be impossible and/or too power hungry for the device to perform SAR image reconstruction. In this case, the device would transmit (off-load) the radar data to, for example, the edge cloud which then reconstructs the SAR image from the collected radar data.

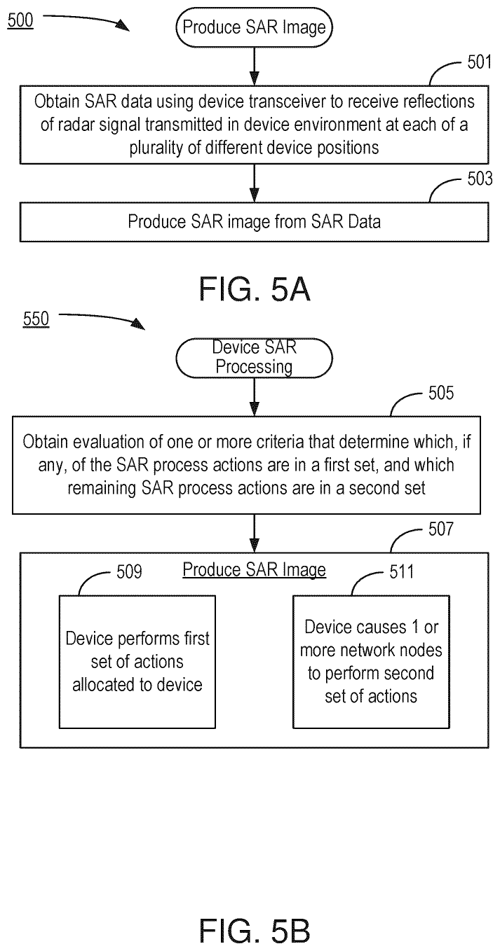

Further aspects of some but not necessarily all inventive embodiments will now be described with reference to FIGS. 5A and 5B, which are, in one respect, flowcharts of actions performed by an exemplary mobile communication device configured to perform SAR sensing and SAR processing allocation in accordance with a number of embodiments. In other respects, the blocks depicted in FIGS. 5A and 5B can also be considered to represent means 500, 550 (e.g., hardwired or programmable circuitry or other processing means) for carrying out the described actions.

FIG. 5A shows actions performed in connection with production of a SAR image. A mobile device obtains SAR data using its transceiver to receive reflections of a radar signal transmitted in an environment of the mobile communication device at each of a plurality of different positions of the mobile communication device (step 501). The collected radar data is then processed to produce a SAR image (step 503).

FIG. 5B shows further aspects of SAR operation in accordance with some inventive embodiments. In a workload allocation action, the device obtains an evaluation of one or more criteria that determine which, if any, of the SAR process actions are in a first set and which remaining SAR process actions are in a second set (step 505).

Then, the SAR image is produced (step 507), for example by performing the actions illustrated in FIG. 5A, with performance of the actions being allocated as decided in step 505. Accordingly, the mobile communication device performs the first set of SAR process actions (step 509) and the one or more nodes in the network are caused to perform the second set of SAR process actions (step 511).

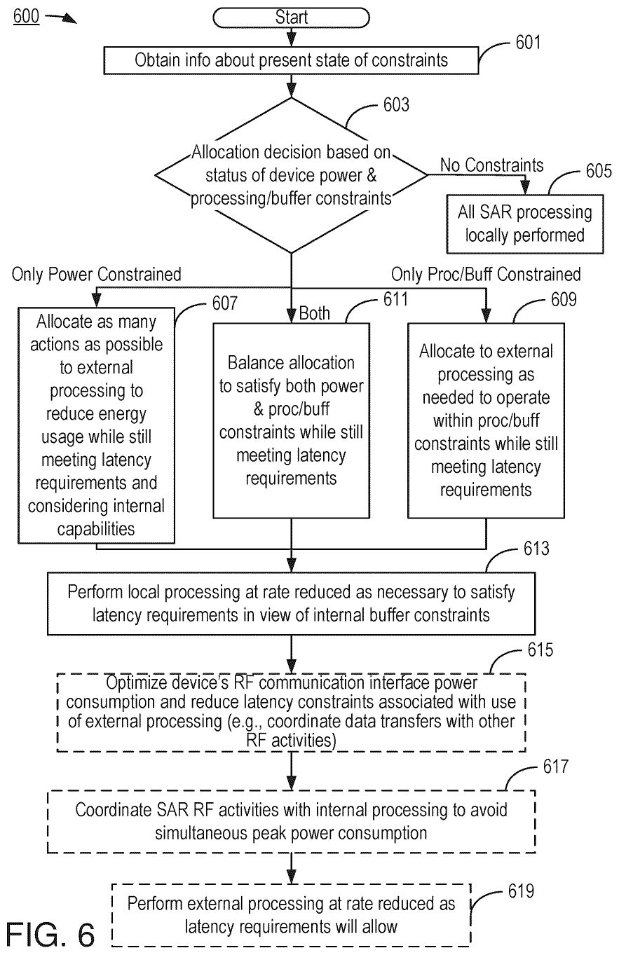

Further aspects of some but not necessarily all inventive embodiments are now described with reference to FIG. 6 which is, in one respect, a flowchart of actions performed by an exemplary mobile communication device configured to perform SAR sensing and SAR processing allocation in accordance with a number of embodiments. In other respects, the blocks depicted in FIG. 6 can also be considered to represent means 600 (e.g., hardwired or programmable circuitry or other processing means) for carrying out the described actions.

As shown in FIG. 6, the process includes the mobile device obtaining information about the present state of constraints (step 601). These constraints can change dynamically. For example, when power is obtained from a battery, it can become depleted over time. Also, latencies to external servers can change as the communication load in the network varies over time. Also, the required SAR performance requirements, such as size and resolution, can change over time because different target objects can have different properties. Additionally, the scan speed can change over time, since this is related to latencies associated with trajectory guidance and buffer size.

The mobile device then makes an allocation decision concerning which SAR process actions are to be performed by the device itself, and which if any remaining actions are to be performed by external processing, such as by an edge cloud. The allocation decision is based on whatever power, processing and/or buffer constraints may exist (decision block 603), and this information is made available to the device. For example, it is advantageous for the SAR application to have knowledge of the SAR performance requirements, for example, with respect to object size, required resolution, and scanning speed. The SAR application can also receive information about available memory, processing capabilities, and power. Information for estimating latencies associated with external processing can vary dependent on, for example, where the edge server is placed relative to the device (i.e., the path from device to edge server). Such information can be obtained in a number of ways such as, without limitation, sending an inquiry to the edge server, performing some initial testing, and learning over time.

If there are no constraints whatsoever (e.g., if the mobile device has an ample supply of power, sufficient processing capacity to satisfy latency requirements, and sufficient space for buffering collected data), the allocation may have all SAR processing performed locally (step 605) (“No constraints” path out of decision block 603).

In another possibility, power is the only constraint (“Only Power Constrained” path out of decision block 603). In this case, as many actions as possible are allocated to external processing in order to reduce energy usage, while making sure that the device's capabilities can support the allocation (e.g., ensuring that there is sufficient power for communicating SAR data over the radio interface) and ensuring that latency requirements can still be met with the allocation (step 607).

In another possibility, there is ample power (e.g., the device is plugged in to a power supply) but processing capacity and or buffer capacity present constraints (“Only Proc/Buff Constrained” path out of decision block 603). In this case, SAR process actions are allocated to external processing to the extent needed to operate within the processing/buffer constraints while still meeting latency requirements (step 609). It is noted that allocation of SAR process actions to external processing can increase latency due to, for example, the need to communicate the collected radar data to the external processing entity and subsequently the processed SAR image back to the device.

In yet another possibility, there are power constraints as well as processing/buffering constraints (“Both” path out of decision block 603). In this case, the strategy seeks to balance allocation of SAR process actions between some being performed locally at the device, and remaining actions being performed externally (e.g., by an edge cloud), such that all of the power and processing/buffering constraints are satisfied while also meeting all latency requirements (step 611).

In another aspect of some but not necessarily all embodiments consistent with the invention, a further power saving step includes performing local processing at a rate that is reduced but still high enough to satisfy latency requirements in view of internal buffer constraints (step 613). For example, slowing the processing too much can cause a buffer to reach capacity and overflow.

In another aspect of some but not necessarily all embodiments consistent with the invention, a further power saving step includes optimizing the device's RF communication interface power consumption by, for example, coordinating data transfers with other RF activities (step 615). To provide more freedom for coordinating SAR data transfers with other RF activities, turn-around latency requirements of the external node can be relaxed by arranging for latency-critical SAR data to be processed locally. These aspects are described further later in this disclosure.

In yet another aspect of some but not necessarily all embodiments consistent with the invention, a further power saving step includes coordinating SAR RF activities with internal processing to avoid causing peak power consumption of each of these activities from occurring simultaneously (step 617).

In still another aspect of some but not necessarily all embodiments consistent with the invention, a further power saving step includes setting the frequency of external processing to a reduced level that still satisfies latency requirements (step 619).

In any of the above-mentioned aspects, it is necessary to assess the amount of power consumption of the device's wireless communication interface in order to determine what the device's total energy consumption will be, and to what extent external processing is more beneficial. The power consumption of the device's wireless communication interface depends on:
1. Wireless communication interface latency constraints (as part of the external processing loop), where fewer constraints would allow more power optimizations
2. The device's SAR buffer. Larger buffers improve the possibilities for interface power optimizations.

For the first of the above-mentioned considerations, some amount of local processing could relieve wireless communication interface latency constraints (e.g., because it reduces the amount of required communication between the device and external processing and makes it easier to coordinate SAR-related communication with other RF activities), and this should be considered for the processing split determination. Another side effect of assigning most critical latency aspects to local processing is that the external node(s) can also operate in a more power efficient manner due to the reduction in the overall turnaround latency constraints.

As illustrated in the figure, at least a baseline amount of local processing may be needed to fulfill stricter latency requirements associated with tasks such as SAR trajectory guidance. In this example, at least partial processing for SAR trajectory guidance may need to be performed locally if complete reliance on external processing would require loop turnaround times that are too long to satisfy latency requirements, or if fulfilling them would come with other essential drawbacks such as increasing device total energy consumption or being very spectrum inefficient of system resources.

In some but not necessarily all inventive embodiments, the fraction of SAR processing actions assigned for local processing considers local loop latency (which can change dynamically depending on, for example, the SAR trajectory speed) and remaining buffer capacity so that data is processed at a minimum processing speed that is just sufficient to satisfy local latency constraints without exceeding buffer capacity.

In another aspect of some embodiments, the timing of local processing and SAR RF transmission is coordinated to reduce peak power consumption (e.g., by ensuring that these do not take place at the same time).

In yet another aspect of some embodiments, latency reductions attributable to local processing allows more leeway with respect to scheduling communication of data over the wireless communication interface, so communication scheduling can be designed to optimize utilization of the wireless communication interface (e.g., by communicating more data over fewer communication instances).

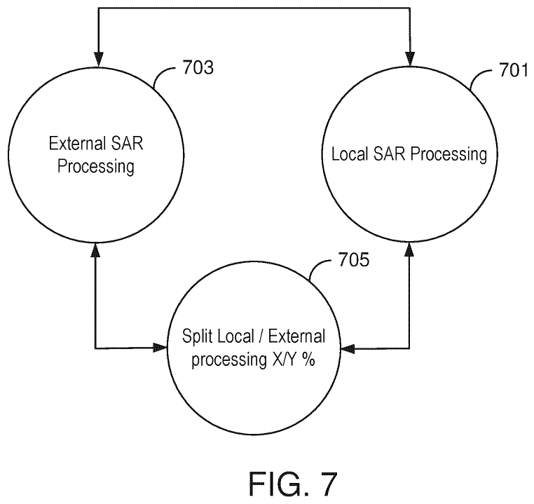

To further illustrate aspects of some inventive embodiments, FIG. 7 shows the dynamic switching between different modes of SAR processing allocation. Three modes are illustrated: a first mode 701 in which all SAR processing is performed locally within device, a second mode 703 in which all SAR processing is performed external to the device, and a hybrid, third mode 705 in which some SAR processing actions are allocated to local processing and in which remaining SAR processing actions are allocated to external processing. The modes can change dynamically over time dependent on such things as, without limitation:
Current SAR processing latency requirements
Current processing loop characteristics (e.g., delays associated with respect local and external processing, and associated with communication between the entities)
Required SAR performance (e.g., size of the object to be scanned, required resolution, and scanning speed)

For example, consider an embodiment in which external processing provides guidance for a SAR trajectory 205, 401. The external processing needs to analyze radar data collected so far and determine a movement of a scanning device (in the case of SAR) or of an object to be scanned (in the case of ISAR) such that data needed to complete the SAR image can be collected. Then, the external processing needs to communicate movement instructions to a user of the device (in the case of manual movement-the instructions can be text, visual, and/or audible), or to a controller of a mechanical scanner 203 (e.g., as shown in FIGS. 2, 4A, and 4B), or to a controller of an object to be scanned (i.e., in the case of ISAR). Both the movement determination and the communication of instructions adds a corresponding latency to the consideration. When deciding whether a given allocation will satisfy overall latency requirements, a consideration is trajectory speed and related SAR trajectory guidance latency because, for example, a fast trajectory speed requires a shorter loop latency than a slow speed. For a slow trajectory speed and related reduced latency constraints, it might be possible to fulfill all processing externally, which is more energy efficient. By contrast, a faster control loop might require and be most power efficient by allocating a fraction of the SAR processing to be performed locally. However, in order to allocate some processing to the device, it must further be considered whether the required SAR image resolution exceeds a threshold amount associated with a maximum processing capability of the device.

Another example considers the effect of external processing loop characteristics (e.g., the wireless communication interface, wired interfaces, communication nodes and external processing node). This loop could introduce different levels of latencies depending on the device position in the cellular network. The characteristics of the wireless interface could impact this part of the device energy consumption (e.g., a large distance to a base station would mean a higher transmit power). Accordingly, some but not necessarily all inventive embodiments take this into account when deciding how to allocate the SAR processing actions.

As mentioned above, one power saving strategy involves coordinating the timing of SAR actions (e.g., scanning by the device and/or communication of radar information between the device to the external processing) with the device's other communication steps (e.g., unrelated to SAR). Aspects of this strategy are described in the following.

For a device sending radar data to a base station via a communication channel, uploading the radar data at each radar sampling point may result in high device power consumption. But the alternative, just collecting and buffering radar data at all sampling points during a SAR scanning and then uploading the data all at once, may require a large buffer memory in the device. To avoid both problems, the cooperation between radar actions and communication activity is necessary. To assist with the cooperation, taking other steps (such as those described above) can reduce latency constraints on the wireless communication interface (as part of external loop latency constraints) and thereby allow for more scheduling flexibility and the improved power efficiency that results.

If the digital processing of the SAR data is performed at an external entity (e.g., edge cloud) instead of internally within the device (e.g., due to lack of processing capability, lack of memory or due to power consumption reasons), the SAR data needs to be transmitted to the external entity via wireless communication. For the sake of device power saving, the device RF duty cycle for communication should be kept low to allow for longer sleep durations. The ability to optimize this depends on:
(a) Available RF data memory buffer
(b) The level of trajectory guidance interaction between the device and the external processing entity. This level is based on already scanned and processed SAR data.
(c) Determining the data processing turn around latency from the external entity. This is dependent on the SAR sampling frequency and its relation to trajectory speed.

As an example, a device having a large buffer memory and no need to use SAR processed data to guide SAR trajectory would not have any strict turn around latency requirement and could optimize the duty/sleep durations of its RF communication-related activity and even coordinate this with other ongoing RF active events to optimize the device RF power consumption.

But if the SAR scanning trajectory guidance needs continuous fast feedback from processed data and/or if there is only a small memory buffer available, more regular and periodic RF data transmissions/receptions with short bursts of data would be required, preventing optimal communication related RF power consumption. The ability to schedule the latter would also be more restricted since frequent and regular communication-related RF data transmissions/receptions and SAR RF scan events need tight alignment if using the shared HW implementations.

To illustrate operation in the third mode 705 in which some SAR processing actions are allocated to local processing and in which remaining SAR processing actions are allocated to external processing, consider embodiments in which local processing is used to perform low resolution image processing for guiding/controlling the SAR trajectory, and remote SAR processing to obtain a higher resolution image. Such a strategy allows memory buffer utilization associated with local processing to remain below a maximum threshold amount (i.e., because the local low-resolution processing is configured to be sufficient for trajectory feedback) while reducing the external entity turnaround time for data processing (i.e., because the external entity is not slowed by performing SAR trajectory guidance formulation). (If a good cellular connection is available, data that is sent to an external server for processing can be sent regularly without the need for much buffering.) The benefits include:
The “shorter” inner loop for trajectory guidance will be independent of the round-trip latency to external entity and this lowers the turnaround latency constraint. A reduced turnaround latency constraint in turn creates more freedom with how to schedule RF data transfers to optimize power consumption associated with the data transfer.
The avoidance of frequent RF communication puts less restriction and constraints for SAR scan and RF communication when those functions share device resources (e.g., transceiver circuitry) and simultaneous use of the resource(s) is not possible.
The low resolution local trajectory input processing can be used and enabled specifically in scenarios where low latency communication with an external entity (e.g., edge cloud) is not possible at the moment (e.g., due to dynamically changing circumstances based on, for example, network deployment and performance) but trajectory guidance is still needed
Feedback of SAR trajectory guidance can be made faster and/or power efficiency can be increased by maintaining the speed of SAR trajectory guidance at an acceptable level while allowing the speed of low resolution local processing to be lowered.
The higher resolution SAR image produced by the remote SAR processing and potentially also object recognition may also be used to better and more efficiently further guide the SAR scanning trajectory in a manner that reduces device radar RF power consumption when creating the full image (e.g., because the amount of unnecessary radar data is reduced, thereby eliminating the need to process and/or assess and discard this data)

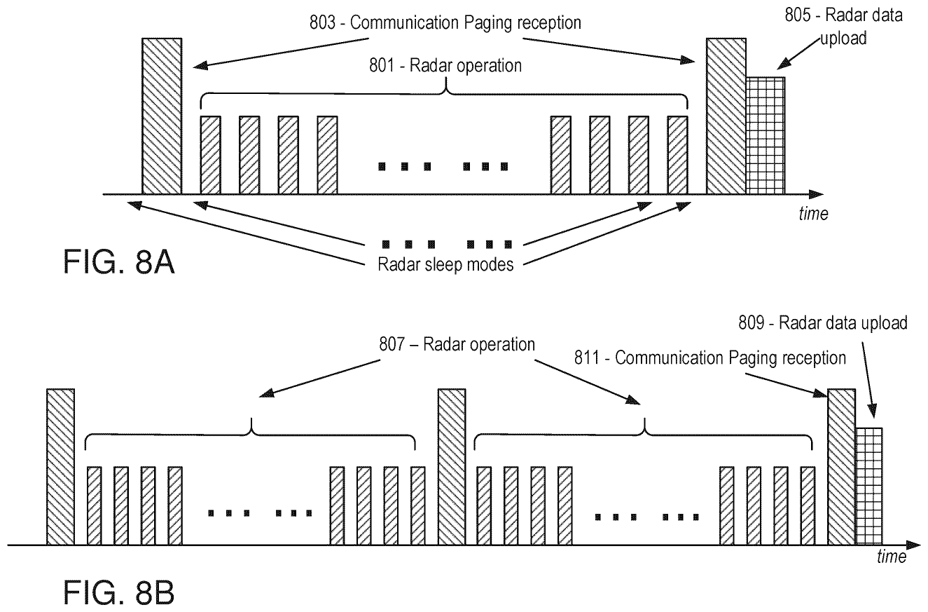

Referring now to FIGS. 8A and 8B, the description will now focus on embodiments in which the timing of the device's SAR-related activities is coordinated with other activities to achieve further power optimization. In some embodiments, when the device is in RRC Idle/Inactive (for example as defined in 3GPP standards), the performance of SAR scanning can be synchronized with the device's DRX wakeup cycle for communication paging so that the number of extra device sleep/wakeup transitions is reduced. For example, during idle/standby mode, a mobile device has to wake up periodically (e.g., every 1.28 s) to monitor its paging information from cellular network. The device can perform SAR radar scanning during the 1.28 s period (i.e., in between the monitoring instances) and buffer its radar data. Once the device wakes up for communication paging reception, it can set up the connection to the network and transfer the buffered radar sampling data. This class of embodiments is illustrated in FIG. 8A which illustrates a radar operation 801 being performed in between communication paging receptions 803, with the collected radar data being uploaded (805) just following the next-occurring communication paging reception instance 803. It will be appreciated that the radar data could alternatively be uploaded just before the next-occurring communication paging reception instance 803. In either case, power consumption is optimized by reducing the number of times the transceiver needs to be activated.

Dependent on the radar sampling data buffer status, further power efficiencies may be achieved by configuring the device to collect radar data over multiple DRX cycles and then transfer the data after one of these multiple DRX cycles. This class of embodiments is illustrated in FIG. 8B, which shows radar data collection 807 being performed in each of two DRX cycles, and the uploading of radar data 809 being performed only after the last occurring communication paging reception instance 811 associated with the multiple DRX cycles.

The examples shown in FIGS. 8A and 8B illustrate alignment of radar data uploading with communication paging reception instances 803, 811. In aspects of further embodiments, reception of processed SAR data from external processing can also be aligned with other communication events to achieve additional efficiencies. Figures illustrating such embodiments could look essentially like the embodiments of FIGS. 8A and 8B, except that processed SAR data reception would be substituted in place of radar data uploading 803, 809.

The inventors of the disclosure have recognized that the nature of SAR scanning typically results in a large volume of discrete datasets (or scan sessions) that will have signal artifacts at the ingress and regress of each scanned interval, and that these are less useful when putting together the SAR image. Accordingly, in an aspect of some but not necessarily all inventive embodiments, the value versus cost of generating the initial data points is used to achieve substantial device resource savings by configuring the SAR actions to engage with ramp up in power, rate and bandwidth in order to minimize the power used to collect these datapoints, since they need to be filtered out and discarded anyway. Unless taken into account, the wasted data can become a substantial portion of the total power due to the sequential nature of the SAR calculations. It is noted that the use of a circular scanning path might be the only variant that can use most captured data and result in less number of wasted end-points.

In yet another aspect of some but not necessarily all inventive embodiments, in order to reduce high peak power consumption during SAR scanning, a buffering mechanism is implemented to even out the power consumption. Lowering peak power can reduce the implementation complexity and can allow for a more efficient distribution of power between the power source and any given power consumer within the device. Furthermore, which radar data and/or the amount of the data to be buffered can be adapted in accordance with one or more of the aspects described above.

More particularly, while performing SAR scanning, a device's RF circuits and ADC are enabled only for radar operation and the radar data is buffered, all while the radar/SAR digital processor is maintained in a deep sleep state (e.g., powered off). In between radar operation events (i.e., when the RF circuits are not active), the radar/SAR digital processor is enabled to do radar data processing. This coordination of task timing prevents the RF circuitry and processing circuitry from being simultaneously active, and has the benefit of lowering peak power consumption.

In another aspect of some but not necessarily all inventive embodiments, during SAR digital processing, the device power consumption is reduced by lowering the speed of the digital processing circuit to a target minimum. The minimum processing speed is determined by the required processing latency which in turn is determined by
a. Available SAR data memory buffer
b. The level of trajectory guidance interaction, which is based on already scanned and processed SAR data

For example, a device with a large buffer memory and no need to use SAR processed data to guide the SAR trajectory would not have any strict latency requirement aside from some upper latency boundary for creating the SAR image will exist though. Such a device can therefore be permitted to perform digital processing at a target minimum speed and thereby at lower the processing power consumption (e.g., by adjusting supply voltage). By comparison, a scan trajectory guidance requiring continuous fast feedback from processed data and/or a device having only a small buffer would require a more regular processing of data with bounded latency requirements (which are dependent on SAR sampling frequency in relation to trajectory speed) and this lowers the possibility of reducing the processing frequency.

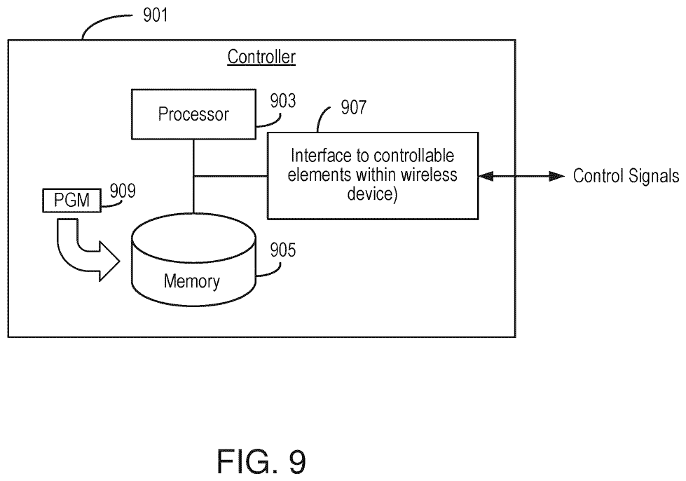

Further aspects of embodiments consistent with the invention will now be described with reference to FIG. 9, which shows an exemplary controller 901 that may be included in a device 101, 151 to cause any and/or all of the herein-described and illustrated actions associated with the device 101, 151 to be performed. In particular, the controller 901 includes circuitry configured to carry out any one or any combination of the various functions described herein. Such circuitry could, for example, be entirely hard-wired circuitry (e.g., one or more Application Specific Integrated Circuits—“ASICs”). Depicted in the exemplary embodiment of FIG. 9, however, is programmable circuitry, comprising a processor 903 coupled to one or more memory devices 905 (e.g., Random Access Memory, Magnetic Disc Drives, Optical Disk Drives, Read Only Memory, etc.) and to an interface 907 that enables bidirectional communication with other elements of the device 101, 151, such as any one or more of the elements illustrated in FIGS. 1A and 1B. A complete list of possible other elements is beyond the scope of this description.

The memory device(s) 905 store program means 909 (e.g., a set of processor instructions) configured to cause the processor 903 to control other device elements so as to carry out any of the aspects described herein. The memory device(s) 905 may also store data (not shown) representing various constant and variable parameters as may be needed by the processor 903 and/or as may be generated when carrying out its functions such as those specified by the program means 909.

Embodiments consistent with the invention provide a number of advantages over conventional technology. For example, and without limitation:
The power efficiency of the SAR scanning by a mobile device can be improved.
For a device performing SAR scanning, the technology can achieve the tradeoff between device power consumption and the time latency of SAR image generation.
The determined fraction of local SAR processing can be used to lower latency constraints sufficiently to enable trajectory guidance by an external entity that cannot otherwise be met by an external processing loop.
The determination allocation of SAR process actions between local and external processing also considers latency reductions on the wireless communication interfaces and its impact on the total energy efficiency.

It is further noted that the embodiments are not dependent on the radar being operated in 3GPP spectrum, and are not dependent on the radar being implemented as integrated in the

Moreover, embodiments in which a mobile device utilizes mmWave SAR sensing provides further advantages with respect to the ability to sense otherwise hidden objects at high resolution.

The invention has been described with reference to particular embodiments. However, it will be readily apparent to those skilled in the art that it is possible to embody the invention in specific forms other than those of the embodiment described above.

For example, the various embodiments have made reference to an edge server. However, the use of an edge server is not an essential aspect of inventive embodiments. To the contrary, any server or collection of servers or processing entities performing the herein-described functionality may be used (e.g., a cloud server as well as a server located in mobile network such as but not limited to a mobile edge cloud), and the term “server” is accordingly used herein to denote any such embodiment.

Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. A method of producing a synthetic aperture radar (SAR) image of a target, the method being performed by a mobile communication device and comprising:
causing a SAR image process to be performed, wherein the SAR image process comprises a plurality of SAR process actions comprising:
obtaining SAR data by operating a transceiver of the mobile communication device to receive reflections of a radar signal transmitted at each of a plurality of different positions of the mobile communication device relative to the target; and
producing the SAR image from the SAR data,
wherein causing the SAR image process to be performed comprises:
causing the mobile communication device to perform a first set of the SAR process actions; and
causing the one or more nodes in a network to perform a second set of the SAR process actions,
wherein allocation of the SAR process actions between the first set of the SAR process actions and the second set of the SAR process actions is based on an evaluation of one or more criteria.

2. The method of claim 1, wherein the one or more criteria are dependent on one or more of:
a power constraint of the mobile communication device;
a processing resource constraint of the mobile communication device;
a buffer constraint of the mobile communication device;
an amount of power consumption required to communicate between the mobile communication device and the one or more nodes in the network; and
a target resolution of the SAR image.

3. The method of claim 1, wherein the one or more criteria include a maximum latency requirement.

4-9. (canceled)

10. The method of claim 1, comprising:
adjusting a SAR processing speed based on a measure of available memory for storing SAR data.

11. The method of claim 1, comprising:
adjusting how frequently collected SAR data is communicated to the one or more network nodes based on a measure of available memory for storing the collected SAR data.

12. The method of claim 1, comprising:
adjusting a speed of performance of the SAR image process based on a level of interaction between the mobile communication device and the one or more nodes in the network that is related to scanning trajectory guidance.

13. The method of claim 1, comprising:
adjusting a speed of performance of the SAR image process based on a threshold level of maximum acceptable processing latency.

14. The method of claim 1, wherein the SAR process actions comprise:
determining further radar scans that need to be performed by the mobile communication device to obtain the SAR data.

15. The method of claim 1, wherein the mobile communication device periodically activates a wireless transceiver to perform a network activity at predefined instances, wherein the network activity comprises one or more of receiving and transmitting a signal respectively from and to the network, and wherein the method comprises:
causing the mobile communication device to perform radar scans in between the predefined instances;
storing radar information obtained from the radar scans in a buffer; and
maintaining the mobile communication device in an awake state throughout a time interval during which the mobile communication device:
performs the network activity at one or more of the predefined instances; and
communicates the stored radar information to the one or more nodes of the network.

16. The method of claim 15, wherein the network activity comprises:
monitoring paging information from the network.

17. A non-transitory computer readable medium having stored thereon a computer program comprising instructions that, when executed by at least one processor of a mobile communication device, causes the at least one processor to carry out a method of producing a synthetic aperture radar (SAR) image of a target, the method being performed by a mobile communication device and comprising:
causing a SAR image process to be performed, wherein the SAR image process comprises a plurality of SAR process actions comprising:
obtaining SAR data by operating a transceiver of the mobile communication device to receive reflections of a radar signal transmitted at each of a plurality of different positions of the mobile communication device relative to the target; and
producing the SAR image from the SAR data,
wherein causing the SAR image process to be performed comprises:
causing the mobile communication device to perform a first set of the SAR process actions; and
causing the one or more nodes in a network to perform a second set of the SAR process actions,
wherein allocation of the SAR process actions between the first set of the SAR process actions and the second set of the SAR process actions is based on (505) an evaluation of one or more criteria.

18. (canceled)

19. An apparatus for producing a synthetic aperture radar (SAR) image of a target, the apparatus being comprised in a mobile communication device and the apparatus comprising:
circuitry configured to cause a SAR image process to be performed, wherein the SAR image process comprises a plurality of SAR process actions comprising:
obtaining SAR data by operating a transceiver of the mobile communication device to receive reflections of a radar signal transmitted at each of a plurality of different positions of the mobile communication device relative to the target; and
producing the SAR image from the SAR data,
wherein the circuitry configured to cause the SAR image process to be performed comprises:
circuitry configured to cause the mobile communication device to perform a first set of the SAR process actions; and
circuitry configured to cause the one or more nodes in a network to perform a second set of the SAR process actions,
wherein allocation of the SAR process actions between the first set of the SAR process actions and the second set of the SAR process actions is based on an evaluation of one or more criteria.

20. The apparatus of claim 19, wherein the one or more criteria are dependent on one or more of:
a power constraint of the mobile communication device;
a processing resource constraint of the mobile communication device;
a buffer constraint of the mobile communication device;
an amount of power consumption required to communicate between the mobile communication device and the one or more nodes in the network; and
a target resolution of the SAR image.

21-27. (canceled)

28. The apparatus of claim 19, comprising:
circuitry configured to adjust a SAR processing speed based on a measure of available memory for storing SAR data.

29. The apparatus of claim 19, comprising:
circuitry configured to adjust how frequently collected SAR data is communicated to the one or more network nodes based on a measure of available memory for storing the collected SAR data.

30. The apparatus of claim 19, comprising:
circuitry configured to adjust a speed of performance of the SAR image process based on a level of interaction between the mobile communication device and the one or more nodes in the network that is related to scanning trajectory guidance.

31. The apparatus of claim 19, comprising:
circuitry configured to adjust a speed of performance of the SAR image process based on a threshold level of maximum acceptable processing latency.

32. The apparatus of claim 19, wherein the SAR process actions comprise:
determining further radar scans that need to be performed by the mobile communication device to obtain the SAR data.

33. The apparatus of claim 19, wherein the mobile communication device periodically activates a wireless transceiver to perform a network activity at predefined instances, wherein the network activity comprises one or more of receiving and transmitting a signal respectively from and to the network, and wherein the apparatus comprises:
circuitry configured to cause the mobile communication device to perform radar scans in between the predefined instances;
circuitry configured to store radar information obtained from the radar scans in a buffer; and
circuitry configured to maintain the mobile communication device in an awake state throughout a time interval during which the mobile communication device:
performs the network activity at one or more of the predefined instances; and
communicates the stored radar information to the one or more nodes of the network.

34. The apparatus of claim 33, wherein the network activity comprises:
monitoring paging information from the network.

35. A mobile communication device comprising the apparatus of claim 19.
